(19) United States
(12) Patent Application Publication
(10) Pub. No.: US 2014/0178047 A1
(43) Pub. Date: Jun. 26, 2014

(54) GESTURE DRIVE PLAYBACK CONTROL FOR CHROMELESS MEDIA PLAYERS

(71) Applicant: The Center for Digital Content, LLC, Venice, CA (US)

(72) Inventors: Thomas Michael Apodaca, San Francisco, CA (US); Benjamin George Olander, Berkeley, CA (US)

(21) Appl. No.: 13/831,538

(22) Filed: Mar. 14, 2013

Related U.S. Application Data
(60) Provisional application No. 61/745,384, filed on Dec. 21, 2012.

(51) Int. Cl. H04N 5/91; G06F 3/041

(52) U.S. Cl. CPC H04N 5/91; G06F 3/041
USPC 386/248

(57) ABSTRACT

Disclosed are configurations for controlling media using a chromeless media player. Gestures performed on a touch sensitive screen are used to modify the behavior of the media player. In one embodiment, a gesture recognizer recognizes a gesture performed on a touch sensitive screen. The behavior of a media player is modified based on the recognized gesture. For example, a tap gesture may toggle a playback state (play/pause) of the media player, a pinch gesture may display a seek screen, a scrub gesture may change the playback time of the media player, etc.

### CROSS REFERENCE TO RELATED APPLICATIONS

This application claims the benefit of U.S. Provisional Application No. 61/745,384 filed Dec. 21, 2012, which is incorporated by reference in its entirety.

### BACKGROUND

1. Field of Art

The disclosure generally relates to the field of media playback, and more particularly to control, navigate and organize videos using a gesture driven video playback control.

2. Description of the Related Art

Media players on a computer system are usually controlled by a user interface or chrome built around the media player. The user interface usually includes buttons or other components to pause/play, seek, and/or fast-forward/rewind an audio-visual file. Oftentimes the components included in the user interface reduce the usable area of the screen for displaying the video, and the buttons on the user interface are not intuitive and/or difficult to use in terms of control granularity, particularly when used with control devices such as a computer mouse or keyboard.

As computing devices have evolved in to be tablets and smartphones, instead of using the conventional user interface to control and navigate within media, a set of gestures can be used in a chromeless media player that does not include any user interface component. However, these gestures are simple function controls that were previously performed by a user interface component, for example, swipe right to page forward or left to page back on a digital magazine mirroring a back key or forward key. Moreover, such control mechanisms suffer issues of control granularity of other conventional user interfaces.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of components of an example machine able to read instructions from a machine-readable medium and execute them in a processor (or controller).

FIG. 2A illustrates a high level block diagram of a typical environment for controlling, organizing and navigating video.

FIG. 2B illustrates a flow chart of a method for controlling media.

FIG. 3A illustrates one example embodiment of a user tapping a touch sensitive screen to play/pause a video.

FIG. 3B illustrates a flow chart for an example embodiment for playing and pausing a video.

FIG. 4A illustrates one example embodiment of a user scrubbing a video forward.

FIG. 4B illustrates a flow chart for an example embodiment of scrubbing a video.

FIG. 5A illustrates one example embodiment of a user fast forwarding a video.

FIG. 5B illustrates a flow chart for an example embodiment of fast-forwarding/rewinding a video.

FIG. 6A illustrates an example embodiment of a user pinching a video to obtain a grid of frames.

FIG. 6B illustrates a flow chart for an example embodiment of performing a pinch function.

FIG. 7A illustrates an example embodiment of a user using the seek function to play a video starting from a specific frame.

FIG. 7B illustrates a flow chart for an example embodiment of seeking a video.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

In addition, the features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of a disclosed system, method and computer readable storage medium that includes using a gesture driven special and physical model to control, organize and navigate video. Embodiments of the invention provide a more intuitive and natural way of controlling, navigating and organizing videos in a touch sensitive screen computing system.

One embodiment of a disclosed system, method and computer readable storage medium that includes computer executable instructions for chromeless media playback control. Embodiments of the invention recognize gestures performed on a touch sensitive screen and identify parameters associated with the gesture. The playback behavior of a media player is then modified based on the recognized gesture.

Gestures recognized by the invention may include tap, pinch, scrub and pan. For example, a tap gesture may modify a playback state (play/pause) of the media player, a pinch gesture may display a seek screen, a scrub gesture may change the playback time of the media player, etc.

Additionally, in some embodiments, the playback behavior of the media player is also modified based on one or more parameters associated with the recognized gesture. For example, the horizontal displacement of a scrub gesture may determine the amount of change of the playback time of the media player.

### Computing Machine Architecture

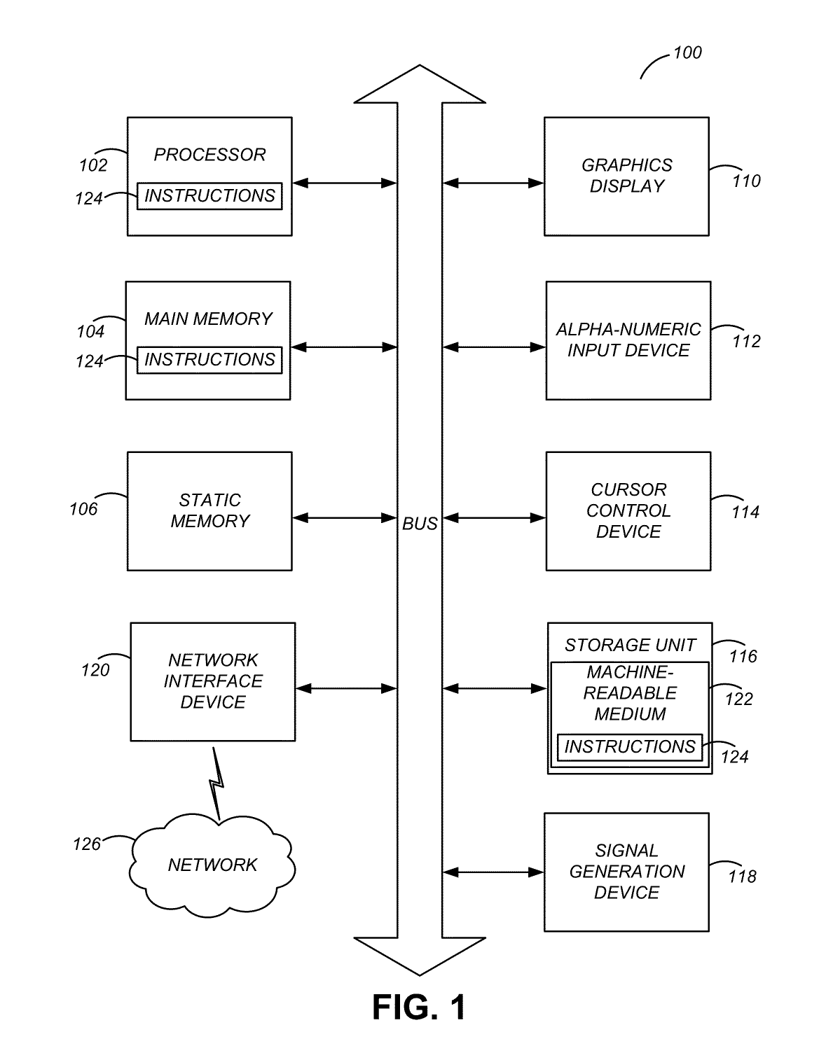

FIG. 1 is a block diagram illustrating components of an example machine able to read instructions from a machine-readable medium and execute them in a processor (or controller). Specifically, FIG. 1 shows a diagrammatic representation of a machine in the example form of a computer system 100 within which instructions 124 (e.g., software) for causing the machine to perform any one or more of the methodologies discussed herein may be executed. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, or any machine capable of executing instructions 124 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 100 includes a processor 102 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 104, and a static memory 106, which are configured to communicate with each other via a bus 108. The computer system 100 may further include graphics display unit 110 (e.g., a plasma display panel (PDP), a liquid crystal display (LCD), a projector, or a cathode ray tube (CRT)). The computer system 100 may also include alphanumeric input device 112 (e.g., a keyboard), a cursor control device 114 (e.g., a mouse, a trackball, a joystick, a motion sensor, or other pointing instrument), a storage unit 116, a signal generation device 118 (e.g., a speaker), and a network interface device 820, which also are configured to communicate via the bus 108.

In a preferred embodiment, for computing systems 100 such as tablets, smartphones and certain laptops with touch sensitive displays, the cursor control device 114 need not be present and may be a software cursor control module. The cursor control module is configured with a touch sensitive device incorporated in the graphics display unit 110, such as a touchscreen. The touchscreen may be configured to detect (or recognize or identify) the position of one or more fingers placed on top of the graphics display unit 110. The touch sensitive device can detect a finger using a resistive panel, a capacitive sensor, an inductive sensor, etc.

The storage unit 116 includes a machine-readable medium 122 on which is stored instructions 124 (e.g., software) embodying any one or more of the methodologies or functions described herein. The instructions 124 (e.g., software) may also reside, completely or at least partially, within the main memory 104 or within the processor 102 (e.g., within a processor's cache memory) during execution thereof by the computer system 100, the main memory 104 and the processor 102 also constituting machine-readable media. The instructions 124 (e.g., software) may be transmitted or received over a network 126 via the network interface device 120.

While machine-readable medium 122 is shown in an example embodiment to be a single medium, the term “machine-readable medium” should be taken to include a single medium or multiple media (e.g., a centralized or distributed database, or associated caches and servers) able to store instructions (e.g., instructions 124). The term “machine-readable medium” shall also be taken to include any medium that is capable of storing instructions (e.g., instructions 124) for execution by the machine and that cause the machine to perform any one or more of the methodologies disclosed herein. The term “machine-readable medium” includes, but not be limited to, data repositories in the form of solid-state memories, optical media, and magnetic media.

### System Architecture

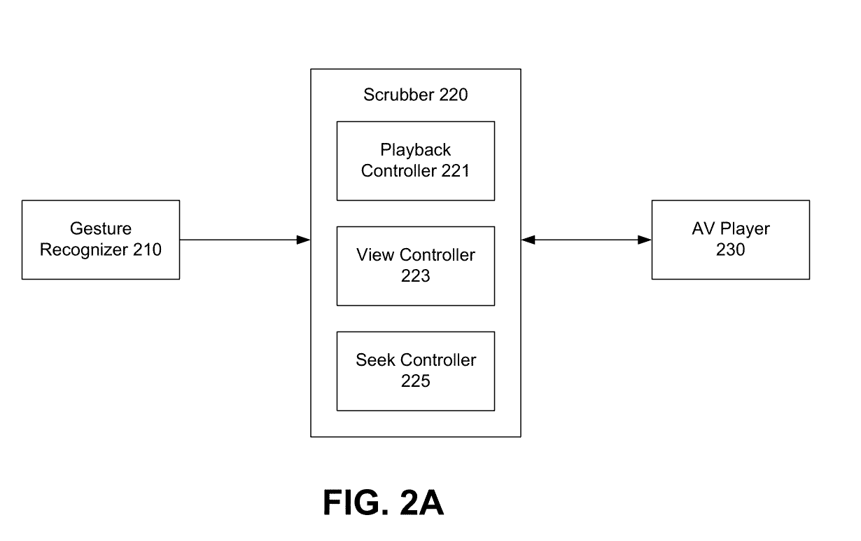

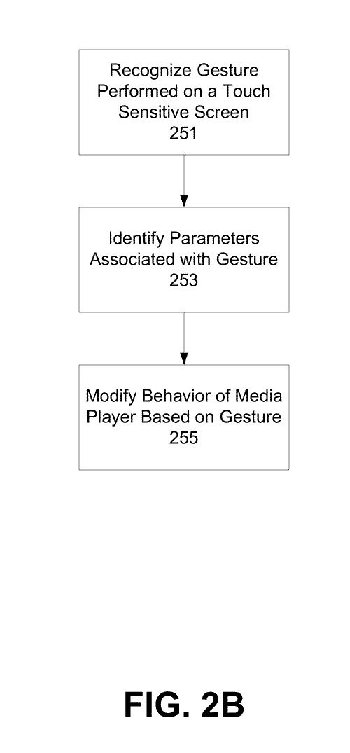

FIG. 2A is a high-level block diagram illustrating a typical environment 200 used for controlling, organizing and navigating video using gesture driven spatial and physical models. The environment 200 includes a gesture recognizer 210, a scrubber 220, and an audio-video (AV) player 230. The gesture recognizer 210 communicatively couples with the scrubber 220. The scrubber 220 communicatively couples with the AV player 230. Each is further described below.

### Gesture Recognizer

The gesture recognizer 210 can recognize different gestures performed by a user on a computing system 100. In one embodiment, the gesture recognizer recognizes gestures performed on a touch sensitive screen (e.g. a touchscreen). In other embodiments, the gesture recognizer recognizes gestures performed by a pointing device (e.g. a mouse, a track pad, etc). Gestures recognized by the gesture recognizer include tap, pinch, pan, and/or scrub. Embodiments of the gesture recognizer 210 can contain separate modules to detect each gesture. For example, the gesture recognizer 210 may contain a tap gesture recognizer to detect a user performing a tap gesture, a pinch gesture recognizer to detect a user performing a pinch gesture, a pan gesture recognizer to detect a user performing a pan gesture, a scrub gesture recognizer to detect a user performing a scrub gesture, etc.

Embodiments of the gesture recognizer can contain components native to the computer system 100. In particular, some of the components of the gesture recognizer can be natively supported by the operating system of the computer system 100. In other embodiments, one or more components of the gesture recognizer may be fully or partially customized.

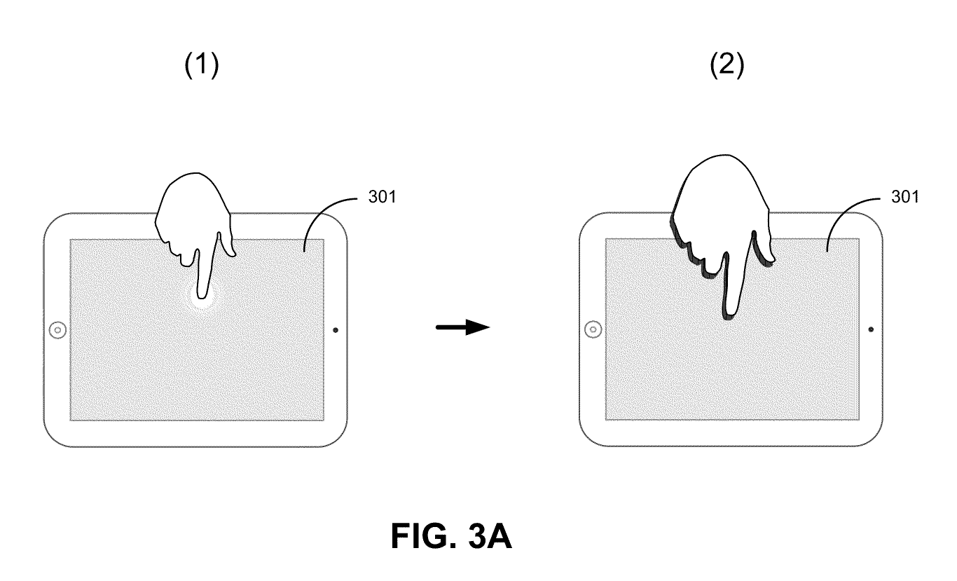

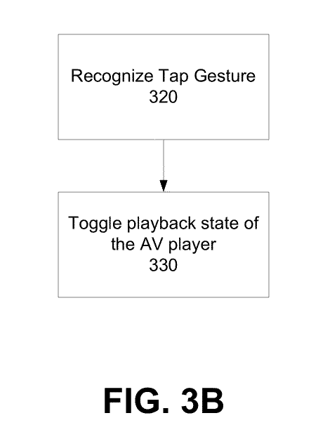

Referring to FIG. 3A, it shows an example embodiment of a tap gesture. The tap gesture is a single tap on the touch sensitive screen 301, which may be coupled with the graphics display unit 110. On a tap gesture, a user (1) places one finger on the touch sensitive screen and (2) quickly lifts the finger (e.g., an extremely small predetermined time period that often is less than a fraction of a second). In some embodiments, for a gesture to be considered a tap, the user has to lift his finger in less than a threshold amount of time. Also in some embodiments, the finger has to move less than a threshold amount of distance from the initial x-y position of the tap gesture. Embodiments of the gesture recognizer returns the x-y position where the finger was first placed on the screen.

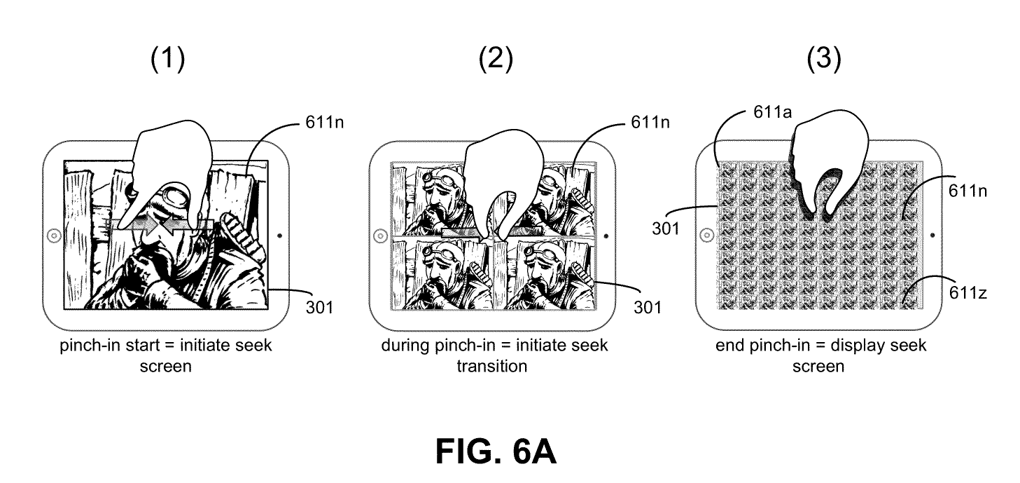

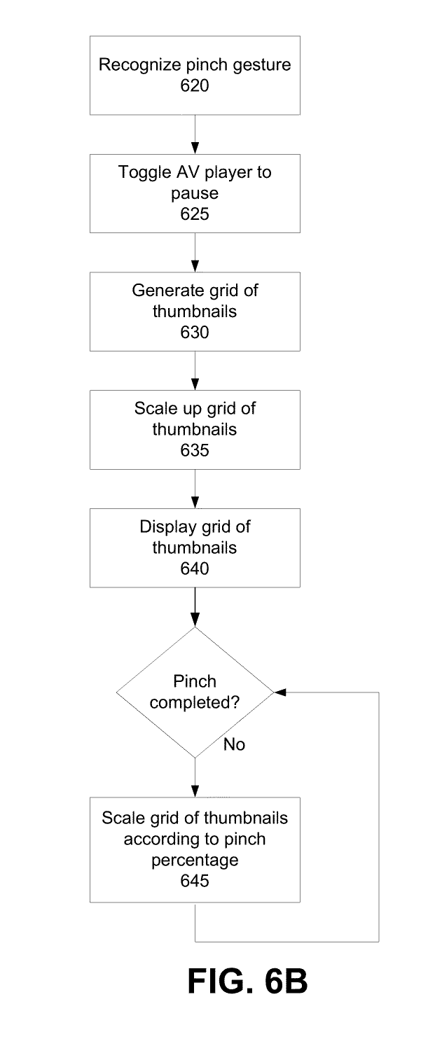

Referring next to FIG. 6A, it shows an example embodiment of a pinch gesture on the touch sensitive screen 301. The pinch gesture consists of two fingers touching the touch sensitive screen and moving towards each other (pinch in) or away from each other (pinch out). In FIG. 6A, the pinch in gesture is illustrated starting from full frame image display in (1). In (2) and (3), the illustration shows an increasing number of frames that are displayed as the pinch in gesture is continued. In some embodiments, the number of frames shown is based on the percentage of completion of the pinch gesture. For example, if the final number of frames is 100, each time the percentage of completion of the pinch gesture is increased, the number of frames displayed is increased, and each time the percentage of completion of the pinch gesture decreases, the number of frames displayed is decreased. This process continues until the percentage of completion of the pinch gesture is 100% and the maximum number of frames is displayed (e.g., 100 frames), or until the user ends the pinch gesture. In some embodiments, the maximum number of frames may be displayed after the pinch gesture reaches a predefined percentage of completion (e.g., 90%).

In other embodiments, the number of frames shown can be based on a mathematical relationship (e.g., doubling, exponential, etc.) between the number of pinches and frames. For example, if the relationship was doubling, in (2), one pinch in gesture may show two frames, two pinches in rapid succession may show four frames, three pinch in actions in rapid success may show 8 frames and so on. The continued rapid succession of pinch in motions would result in a large number of frames as shown in (3).

In one embodiment, each finger has to move at least a threshold amount of distance from the initial position the fingers touched the screen. In one embodiment, both fingers need to be separated at least an initial threshold distance at the beginning of the pinch in gesture and at most a final threshold distance at the end of the pinch in gesture for the pinch gesture to be considered complete. In another embodiment, both fingers need to be separated at most an initial threshold distance at the beginning of the pinch out gesture and at least a final threshold distance at the end of the pinch out gesture for the pinch gesture to be considered complete. In some embodiments, the gesture recognizer outputs a percentage of completion of the pinch gesture every time the value changes (e.g., every time the user moves his fingers closer or further away). In other embodiments, the pinch gesture outputs a percentage of completion of the pinch gesture on a periodic time interval. In one embodiment, instead of outputting a percentage of completion, the pinch gesture recognizer outputs a value between 1 and 0, where a value of 1 signifies the beginning of a pinch gesture and a value of 0 signifies the completion of the pinch gesture.

On a pan gesture, a user first touches the touch sensitive screen with one or more fingers and moves the fingers around the screen before lifting the fingers off the screen. In some embodiments, the gesture recognizer recognizes a pan gesture after the fingers are moved at least a threshold distance away from the initial touch position. In other embodiments, the pan gesture is recognized after the fingers are touching the screen for more than a threshold amount of time. In some embodiments, the gesture recognizer outputs the current x-y position of the finger or fingers. In other embodiments, the gesture recognizer outputs a change in position and/or the speed at which the finger or fingers are moving on the screen.

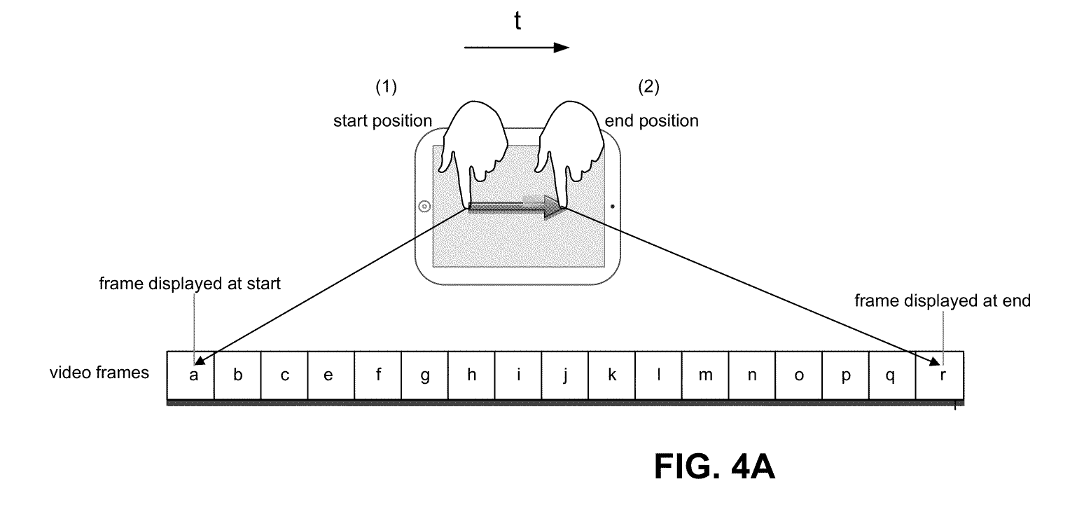

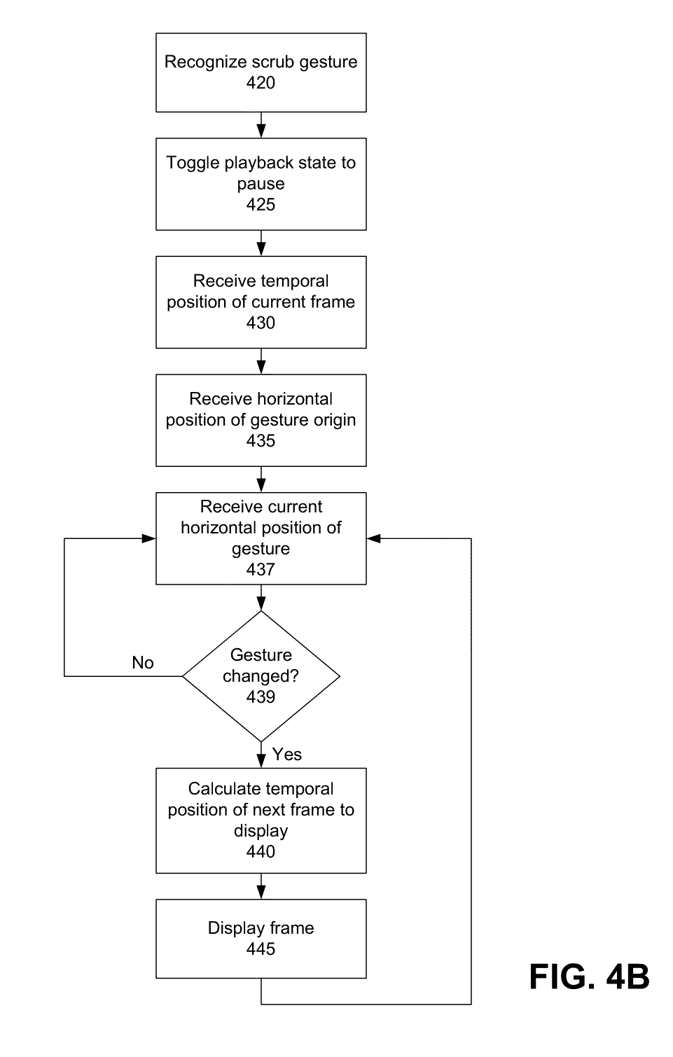

Turning now to FIG. 4A, it shows an example of a scrub gesture on the touch sensitive screen 301. On a scrub gesture, a user (1) touches the touch sensitive screen at a start position and continuously moves his finger in the horizontal direction while continuously maintaining contact with the screen to (2) an end position. In this example, (1) the start position shows video frame “a” and as the finger moves towards (2) the end position successive video frames are shown until the end frame (here, “r”). In one embodiment, the gesture recognizer recognizes a scrub gesture as soon as the user touches the screen sensitive screen. In another embodiment, the finger has to move at least a threshold distance before the gesture recognizer identifies the gesture as a scrub. In other embodiments, the finger has to move at least at a threshold speed before the gesture recognizer identifies the gesture as a scrub. In some embodiments the gesture recognizer outputs the current position of the finger as the user movers the finger to the right or to the left. In other embodiments, the gesture recognizer outputs the horizontal distance traveled by the finger and/or the velocity of the finger moving in the horizontal direction.

### Scrubber

As illustrated in FIG. 2A, the scrubber 220 includes a playback controller 221, a view controller 223 and a seek controller 225. The playback controller 221 is configured to handle media functions such as video or audio play and pause, fast forward or reverse, as well as scrub forward and scrub backward functions as further described herein. The view controller 223 is configured to update the image being displayed on the graphics display 110 when a video is not being displayed by the AV player 230. For example, the view controller 223 is configured to display a catalog of videos for a user to browse, and/or to display a list of frames to allow a user to seek to a part of the video he is interested in. The seek controller 225 is configured to change the current playback time of the AV player 230 after a user selects a frame on a seek screen. Furthermore, the seek controller 225 can also configured to display relevant information, such as temporal information, of the different frames present in the seek screen. Each module is further described below.

The scrubber 220 is configure to respond to gestures detected by the gesture recognizer 210 and controls the video playback of the AV player 230. The scrubber is configured to perform functions including pause/play, scrub forward/backwards, fast-forward/rewind, pinch to seek, and/or touch to seek. Embodiments of the scrubber maps different gestures to a specific function. For example, a tap gesture can be mapped to a pause/play function, a scrub can be mapped to a fast-forward/reverse function, etc.

Turning now to FIG. 2B, it illustrates a flow chart for controlling media using a chromeless media player according to one exemplary embodiment. The gesture recognizer 210 recognizes 251 a gesture performed on a touch sensitive screen. The gesture recognizer may additionally identify 253 one or more parameters associated with the recognized gesture. For example, if a scrub gesture is recognized, the gesture recognizer may identify the horizontal displacement of the fingers touching the touch sensitive screen.

The scrubber 220 is configured to modify 255 the behavior of the media player 230 based on the recognized gesture. Different gestures may modify the behavior of the media player 230 in a different way. For example, a tap gesture may toggle the playback state of the media player from play to pause or vise versa, a pinch gesture may display a seek screen, a scrub gesture may change the playback time of the media player, etc.

### Anywhere Play/Pause

The play/pause function is handled by the playback controller 221. FIG. 3A shows a user playing or pausing a video and FIG. 3B illustrates a flow chart for playing and pausing a video according to one exemplary embodiment. The play/pause function is triggered by a tap anywhere on the touch sensitive screen of the computer system 100. In some embodiments, wherein the computer system 100 does not include a touch sensitive screen, the play/pause function can be triggered by a tap of the cursor control device (e.g. a left click using a mouse). Embodiments as described do not require the tap gesture to be performed in any specific area of the screen or on any particular touch sensitive user interface (e.g. software button). Rather, a tap anywhere on the touch sensitive screen will trigger the AV player 230 to toggle from a play state to a pause state or vice versa.

To play or pause a video, the gesture recognizer 210 recognizes 320 a tap gesture and playback controller 221 toggles 330 the playback state of the AV player 230. In some embodiments, the playback controller checks the status of the AV player 230 and instructs the AV player 230 to change to the pause state if the current state is play, or change to the play state if the current state is pause. Embodiments of the playback controller 220 can check the playback status of the AV Player 230 during the beginning of the tap gesture (during the touch event) or at the end of the tap gesture (during the release event). In other embodiments, the playback controller 220 remembers the current state of the AV player 230 and does not need to check the current playback status whenever the gesture recognizer 210 recognizes a tap event. In other embodiments, the playback controller 320 simply instructs the AV player 230 to toggle playback state and the AV player changes to the opposite playback state it is currently on.

### Scrub Forward and Scrub Backwards

The scrub forward and scrub backward functions are also handled by the playback controller 221. Referring back to FIG. 4A, it shows a user scrubbing a video forward going from (1) the start position to (2) the end position and showing the continuous video frames from “a” to “r” in that example, FIG. 4B illustrates a flow chart of an example scrubbing process for a video and is further described herein. The scrub forward and scrub backwards functions are triggered by a scrub gesture on the touch sensitive screen of the computer system 100. In some embodiments, for example, when the computer system 100 does not include a touch sensitive screen, the scrub function can be triggered by a scrub of the cursor control device (e.g. left click using a mouse and dragging the mouse to the right or left). In one embodiment, a scrub gesture from left to right triggers a scrub forward, and a scrub gesture from right to left triggers a scrub backwards. In contrast, in another embodiment, a scrub gesture from right to left triggers a scrub forward, and a scrub gesture from left to right triggers a scrub backwards.

During a scrub forward or scrub backwards the frame displayed by the AV player changes in response to a change in the horizontal touch position. Furthermore, the frame duration is controlled by the velocity of the horizontal movement. The faster the movement, the shorter the duration of the frame displayed. In some embodiments, the scrub function dynamically adapts to the changes on the scrub gesture. During a scrub gesture, a user may change the speed of the scrub or the direction of the scrub, the scrub function can be configured to adapt to those changes in speed and direction. For example, a user may touch the left portion of the touch sensitive screen, start scrubbing towards the right portion of the screen, slow down the scrub gesture until it comes to a complete stop and start scrubbing back to the left portion of the screen. Responsive to this scrub gesture, the playback controller can direct the AV player to scrub forward as the user scrubs towards the right portion of the screen, slow down the scrub as the user slows down and scrub backwards as the user scrubs back to the left.

In one embodiment, the frame displayed by the AV player during a scrub gesture changes according to the following formula:

New_time=Current_time*Change_in_horizontal_touch*C

wherein New_time is the temporal position of the frame to be displayed, Current_time is the temporal position of the frame displayed at the beginning of the scrub gesture, Change_in_horizontal_touch is the displacement of the scrub gesture, and C is a constant (e.g. −0.004)

Continuing with FIG. 4B, to scrub a video forward or scrub a video backwards, the gesture recognizer 210 recognizes 420 a scrub gesture. The playback controller 221 instructs the AV player to toggle (or change) its playback stage to pause, and responsive to the instruction the AV player pauses 425. The playback controller 221 receives 430 the temporal position of the currently displayed frame from the AV player 230 and receives 435 the horizontal position of the gesture origin from the gesture recognizer 210. The playback controller 221 may also receive 437 an updated horizontal position of the gesture as the user performs the scrub gesture. In some embodiments, the playback controller 221 receives 437 the updated horizontal position periodically. In other embodiments, the playback controller 112 receives 437 the updated horizontal position only when there is a change in the scrub gesture.

Every time the scrub gesture changes 439, the playback controller 221 calculates 440 the temporal position of the frame to be displayed and instructs the AV player 230 to display 445 the frame. Otherwise, if the horizontal position of the scrub gesture did not change since the last time the playback controller 221 received an updated horizontal position from the gesture recognizer 210, the playback controller may simply wait until it receives another updated horizontal position of the gesture and may not calculate the temporal position of the frame to be displayed, since it would be the same as the frame currently being displayed. In some embodiments, the playback controller may calculate 440 the temporal position of the frame to be displayed every time it receives 437 an updated horizontal position of the scrub gesture, without determining whether the horizontal position of the scrub gesture changes since the last time an updated horizontal position was received.

### Fast Forward/Reverse

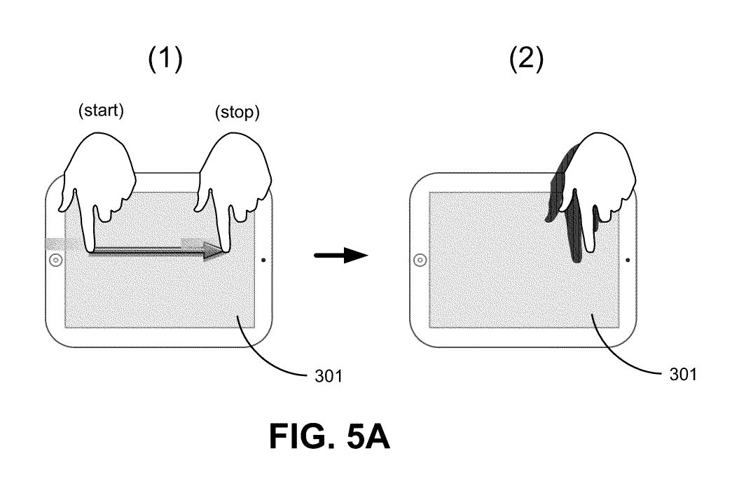

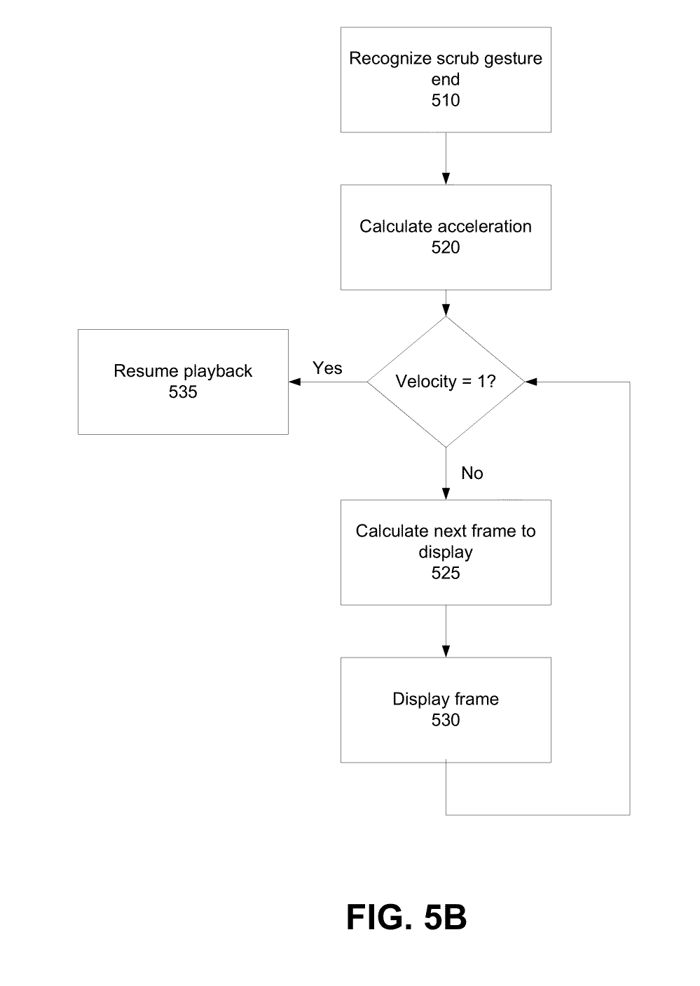

The fast forward/reverse function is also handled by the playback controller 221. FIG. 5A shows a user fast forwarding a video and FIG. 5B illustrates a flow chart for fast forwarding/rewinding a video. The fast forward/reverse function is triggered by (1) a start of a scrub gesture from a start point touched on the screen with continuous motion on the screen at a velocity to (2) an end of a scrub gesture where a user figure is lifted off of the screen. When the scrub gesture ends the velocity of the scrub gesture continues to influence playback speed and direction. For example, if a user is scrubbing forward quickly, the frame display duration will continue to playback at the speed determined upon gesture end, until, it slowly and naturally returns to normal playback speed. Additionally, if the user scrubs backwards, the playback speed will slow to a stop, and slowly pick up speed in the forward direction, until normal playback speed is achieved.

In one embodiment, the velocity changes according to an acceleration calculated by the playback controller 221 at the end of the scrub gesture. In one embodiment, the acceleration is a predetermined constant number, which can be a default number or a number specified by the user. In other embodiments, the acceleration is calculated as:

Acceleration=Velocity*C

where acceleration is the acceleration used to modify the velocity until it reaches the value of 1, velocity is the velocity of the frames at the beginning of the fast forward or reverse and C is a constant (e.g. −0.0001).

After the velocity has reached the velocity of normal playback, the playback controller 221 instructs the AV player 230 to resume playback at a normal speed. In one embodiment, the playback controller 221 instructs the AV player 230 to resume playback with an initial velocity, which depends on the scrub velocity at the end of the gesture, and an acceleration.

Embodiments of the scrub function allow for sequential scrubbing to increase the speed of the scrub function. For example, while moving fast forward or backwards, if the user scrubs a second time, the speed of the second scrub will be added to the velocity of the frames. In one embodiment, the additive feature is only applied if the scrub gestures have at least a threshold velocity. In other embodiments, the additive feature is only applied if the scrub gesture is shorter than a threshold amount of time. Some embodiments will only allow a maximum number of sequential scrubs (e.g. at most 3 scrub gestures in series). Other embodiments will only allow increasing the velocity of playback to a threshold velocity, after which the velocity will not increase even if the user performs more scrub gestures.

In FIG. 5B, the process recognizes 510 the end of a scrub gesture (e.g., illustrated as (2) in FIG. 5A). At the end of this scrub gesture the playback controller 221 calculates 520 the acceleration at which the video should change its velocity until it reaches a velocity of 1 (i.e., a normal playback velocity). Until the velocity of the frames being displayed by the AV player is 1, the playback controller 221 calculates 525 the temporal position of the frame to be displayed based on the calculated acceleration, the velocity of the scrub at the end of the scrub gesture, and the temporal position of the frame being displayed at the end of the scrub gesture, and display 530 the corresponding video frame. When the velocity of the frames being displayed by the AV player reaches 1, the playback controller instructs the AV player to resume playback 535.

### Pinch Transition (Seek)

The pinch transition function is handled by the view controller 223. FIG. 6A shows a user pinching a video to obtain a grid of frames and FIG. 6B illustrates a flow chart for performing the pinch function. The pinch transition is triggered by a pinch gesture performed on the touch sensitive screen of the computer system 100. The pinch transition can be used to transition from one instance of an object to a list of a plurality of instances of the same object. For example, the pinch transition can be used to transition from displaying one frame of a video to a list of frames to perform a seek. Furthermore, the pinch transition can be used to progressively move up a category list. For example, after pinching once to obtain the seek screen, pinching again can take the user to a list of videos as being of a particular genre. Additionally, pinching again can take the user to a list of genres.

After a pinch gesture is recognized, the video freezes on the current frame and begins to shrink in size, revealing a grid of temporally sequential frames sampled from the video file at regular intervals. At the end of the pinch gesture, the user is presented with a grid of temporally sequential frames scaled to fill the screen. The frame scale reduction process takes into account the current time of the frame when the gesture was initiated, and scales it down directionally, so that when the gesture finishes, the frame is appropriately placed relatively in an x/y coordinate system which correlates directly to its relationship to place in time. For example if the user is presented with a 10 by 10 grid of frames, wherein the top left frame 611a is the first frame of the video and the bottom right frame 611z is the last frame of the video, and the frame playing at the beginning of the pinch gesture 611n is the 40^{th} frame, during the pinch gesture, the frame playing at the beginning of the pinch gesture will start scaling down and moving towards the 4^{th} row, 10^{th} column of the final grid as it scales down. Furthermore, as the frame scales down, other frames will start appearing until all the frames are in the correct position.

In one embodiment, as the user performs a pinch gesture, the frame 611n being displayed reduces in size with two points, corresponding to the position of each of the two fingers used to perform the pinch gesture when the pinch gesture began, tracking the two fingers as they move around the touch sensitive screen. As the frame 611n reduces in size, other frames, scaled by the same amount as the frame 611n, start appearing surrounding the frame 611n, creating an array of frames, to fill the empty spaces created by the reduction in size of the frame 611n. When there are no more frames to display on either side of the array of frames, the two points tracking the fingers used to perform the pinch gesture stop tracking the fingers but keeps scaling down in size proportional to the displacement of the fingers relative to each other, until the complete grid of frames is visible on the graphics display 110.

In another embodiment, when the pinch gesture is detected, a large image containing all the frames to be displayed is generated. For example, if the final array is of size 10×10 an image 100 times larger than the screen size is generated and is positioned so that the current frame is the only one being displayed. As the user performs the pinch gesture, the newly generated image decreases in size until all the frames are displayed (i.e. the newly generated image is the same size as the graphics display 110).

In yet another embodiment, when the pinch gesture is detected, a grid of thumbnails (e.g. a grid of 10×10 thumbnails) is assembled and scaled up in size until only one thumbnail fits on the graphics display 110 (e.g. scaled up in size 100 times) and is positioned so that the thumbnail corresponding to the current frame is the only one being displayed. In one embodiment, the view controller 223 receives the current playback time information from the AV player 230 and determines which thumbnail from the grid of thumbnails corresponds to the current playback time and positions the grid of thumbnails accordingly. As the user performs the pinch gesture, the scaled up grid of thumbnails decreases in size until the entire grid is visible on the graphics display 110. In one embodiment, as the grid reduces in size, it is positioned so that the current frame seems to follow the movements of the fingers performing the pinch gesture.

To obtain a seek screen, the gesture recognizer 210 recognizes 620 a pinch gesture. The view controller 223 instructs the AV player to change 625 to a pause state, generates 630 a grid of thumbnails, scales up 635 the grid of thumbnails, and displays 640 the grid of thumbnails on the graphics display 110. As the user progresses with the pinch gesture, the grid of thumbnails is scaled 645 relative to the percentage of completion of the pinch gesture until the pinch gesture has been completed.

### Touch to Seek

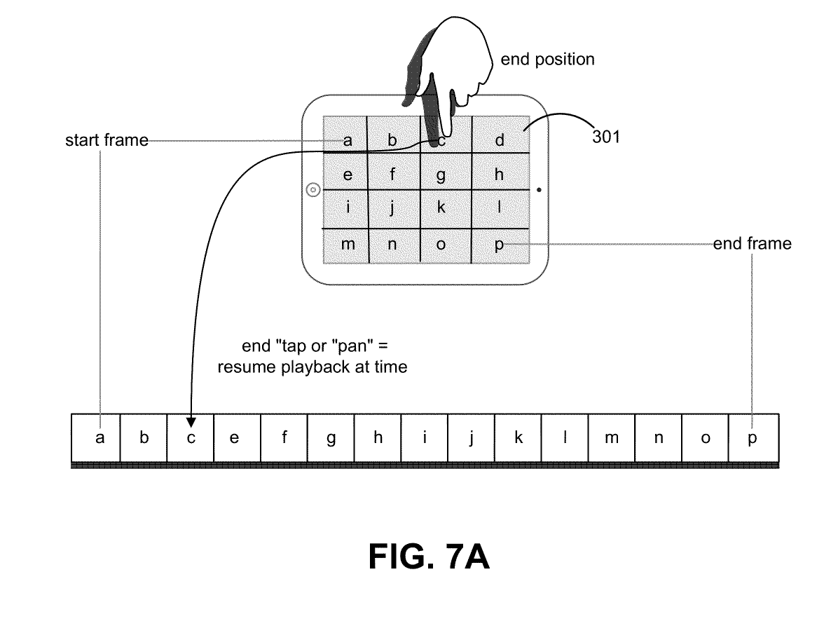

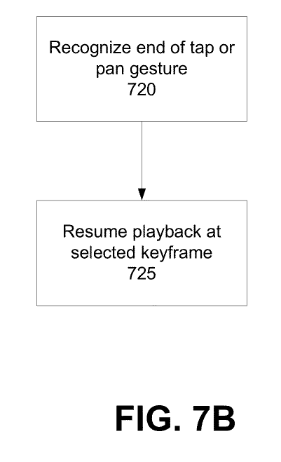

The touch to seek function is handled by the seek controller 225. FIG. 7A shows a user using the seek function to play the video starting from frame “c”. In particular, displayed on the screen 301 is a series of consecutive frames, e.g., start at frame “a” through an end at frame “p” in this example. The user performs, for example, a tap function by a tap action on frame “c” (rapid contact and release of the screen at a specific point, here, the location of frame “c”) or scrub and release as previously described at a location of frame “c” on the screen.

FIG. 7B illustrates a flow chart for seeking a video according to one exemplary embodiment. The seek function is triggered by a tap or pan gesture while on a seek screen. If a user taps on top of a displayed frame on the seek screen, the seek controller 225 instructs the AV player 230 to resume playback at a normal speed starting at the chosen frame. If the user touches a frame and starts panning, the seek controller can display temporal information about the frame being touched. At the end of the pan gesture (i.e., when the user lifts the finger from the touch sensitive screen) the seek controller 225 instructs the AV player 230 to resume playback at a normal speed starting at the frame chosen at the end of the pan gesture.

To seek a video to a specific frame, while on the seek screen, the gesture recognizer 310 recognizes 720 a touch event, wherein the touch even can be a tap gesture or the beginning of a pan gesture. The seek controller instructs the AV player to resume playback 725 starting at the selected frame.

### Additional Configuration Considerations

An advantage of the disclosed configurations is to allow the interaction of a user with an audio/visual player (e.g. a video player) in a more intuitive manner for computing devices with a touch sensitive display. Users can play/pause, fast-forward/rewind, seek and the like with simple gestures without the need of user interface components such as software buttons. Furthermore, the disclosed configuration allows for a simple way of navigating and organizing digital content within a computer or network.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for controlling, navigating and organizing videos using a gesture driven spatial and physical models through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for controlling media comprising:
recognizing a scrub gesture performed on a touch sensitive screen, the scrub gesture recognized by a horizontal movement of a finger touching the touch sensitive screen;
determining a horizontal displacement associated with the scrub gesture;
determining a frame position based on the horizontal displacement associated with the scrub gesture; and
modifying a playback time of a media player based on the determined frame position.

2. The method of claim 1 wherein determining a frame position comprises:
determining a change in playback time, the change in playback time proportional to the horizontal displacement associated with the scrub gesture; and
determining the frame position based on a current frame position and the change in playback time.

3. A method for controlling media comprising:
recognizing a gesture performed on a touch sensitive screen;
identifying one or more parameters associated with the recognized gesture; and
modifying a behavior of a media player based on the recognized gesture and the determined one or more parameters associated with the gesture.

4. The method of claim 3 wherein the recognized gesture is one selected from a group comprising of a tap gesture, a pinch gesture, a scrub gesture, or a pan gesture.

5. The method of claim 4 wherein modifying a behavior of a media player based on the recognized gesture and the determined one or more parameters comprises:
toggling a playback state of the media player in response to recognizing a tap gesture.

6. The method of claim 4 wherein modifying a behavior of a media player based on the recognized gesture and the determined one or more parameters comprises:
displaying a seek screen in response to recognizing a pinch gesture, the seek screen displaying an array of temporally sequential frames sampled in a regular time interval.

7. The method of claim 6 wherein displaying a seek screen comprises:
generating a grid of thumbnails, the thumbnails associated with frames sampled in a regular time interval;
displaying the grid of thumbnails; and
scaling the grid of thumbnails based on a pinch percentage associated with the pinch gesture;

8. The method of claim 6 further comprising:
responsive to receiving a selection of a frame from the seek screen, modifying a playback time associated with the media player.

9. The method of claim 4 wherein modifying a behavior of a media player based on the recognized gesture and the determined one or more parameters comprises:
responsive to recognizing a scrub gesture and determining a horizontal displacement associated with the scrub gesture, determining a frame position based on the horizontal displacement associated with the scrub gesture and modifying a playback time of the media player based on the determined frame position.

10. The method of claim 9 further comprising:
responsive to recognizing an end of the scrub gesture, determining a velocity associated with the end of the scrub gesture and modifying the playback time of the media player based on the determined velocity.

11. A chromeless media controller comprising:
a gesture recognizer configured to recognize a gesture from a plurality of gestures performed on a touch sensitive screen and identify a one or more parameters associated with the recognized gesture; and
a scrubber configured to modify a behavior of a media player based on the gesture recognized by the gesture recognizer and the one or more parameters associated with the gesture.

12. The chromeless media controller of claim 11 wherein the scrubber is configured to toggle a playback state of the media player responsive to the gesture recognizer recognizing a tap gesture.

13. The chromeless media controller of claim 11 wherein the scrubber is configured to display a seek screen responsive to the gesture recognizer recognizing a pinch gesture, the seek screen displaying an array of temporally sequential frames sampled in a regular time interval.

14. The chromeless media controller of claim 13 wherein the scrubber is further configured to:
modify a playback time associated with the media player responsive to receiving a selection of a frame from the seek screen.

15. The chromeless media controller of claim 11 wherein the scrubber is configured to:
responsive to recognizing a scrub gesture and determining a horizontal displacement associated with the scrub gesture, determine a frame position based on the horizontal displacement associated with the scrub gesture and modify a playback time of the media player based on the determined frame position.

16. The chromeless media controller of claim 15 wherein the scrubber is configured to:
responsive to recognizing an end of the scrub gesture, determine a velocity associated with the end of the scrub gesture and modify the playback time of the media player based on the determined velocity.

17. A non-transitory computer readable medium configured to store instructions, the instructions when executed by a processor cause the processor to:
recognize a gesture performed on a touch sensitive screen;
identify a one or more parameters associated with the recognized gesture; and
modify a behavior of a media player based on the recognized gesture and the determined one or more parameters associated with the gesture.

18. The non-transitory computer readable medium of claim 17 wherein modifying a behavior of a media player based on the recognized gesture and the determined one or more parameters causes the processor to:
responsive to recognizing a tap gesture, toggle a playback state of the media player.

19. The non-transitory computer readable medium of claim 17 wherein modifying a behavior of a media player based on the recognized gesture and the determined one or more parameters causes the processor to:
responsive to recognizing a pinch gesture, display a seek screen, the seek screen displaying an array of temporally sequential frames sampled in a regular time interval.

20. The non-transitory computer readable medium of claim 19 further comprising instructions that cause the processor to:
modify a playback time associated with the media player responsive to receiving a selection of a frame from the seek screen.

21. The non-transitory computer readable medium of claim 17 wherein modifying a behavior of a media player based on the recognized gesture and the determined one or more parameters causes the processor to:
responsive to recognizing a scrub gesture and determining a horizontal displacement associated with the scrub gesture, determine a frame position based on the horizontal displacement associated with the scrub gesture and modify a playback time of the media player based on the determined frame position.

22. The non-transitory computer readable medium of claim 21 further comprising instructions that cause the processor to:
responsive to recognizing an end of the scrub gesture, determine a velocity associated with the end of the scrub gesture and modify the playback time of the media player based on the determined velocity.
